(19) United States
(12) Patent Application Publication
(10) Pub. No.: US 2004/0252399 A1
(43) Pub. Date: Dec. 16, 2004

(54) Method and apparatus for data reproducing in information storage system

(76) Inventors: Hideaki Maeda, Odawara (JP); Takehiko Hamaguchi, Odawara (JP); Hitoshi Shindo, Odawara (JP); Kazuyuki Date, Odawara (JP)

Correspondence Address: Mattingly, Stanger & Malur, P.C., Suite 370, 1800 Diagonal Road, Alexandria, VA, 22314, US

(21) Appl. No.: 10/854,166

(22) Filed: May 27, 2004

(30) Foreign Application Priority Data
Jun. 13, 2003 (JP) 2003-169556

(51) Int. Cl. G11B 3/00

(52) U.S. Cl. 360/69

(57) ABSTRACT

The head position is corrected without relying on a servo signal that is positioning information. A readout signal amplitude 122 of a data portion is monitored and, if the readout signal amplitude of the data portion decreases, a read head 101 is compulsorily shifted by a minute width in a direction in which the readout signal amplitude increases, in order to compensate for the positioning error of the read head.

### CLAIM OF PRIORITY

The present application claims priority from Japanese application JP 2003-169556 filed on Jun. 13, 2003, the content of which is hereby incorporated by reference into this application.

### BACKGROUND OF THE INVENTION

1. Technical Field

The present invention relates to an information reproducing apparatus such as a hard disc drive.

2. Background Art

FIG. 2 shows a hard disc drive according to the prior art, and FIG. 3 shows a signal arrangement inside a track. The hard disc drive comprises a read head 101, a recording medium 102, a suspension 103 for retaining the read head, a VCM (voice coil motor) 104 for moving the read head in a radial direction of the disc, a HDC (hard disc controller) 105, and a read/write IC 106 for controlling the VCM and signals during reading and writing. In the hard disc drive, when reading information, the read head 101 reads servo information 119 from a position information signal (to be hereafter referred to as “a servo signal”) that is recorded on the recording medium 102 in advance, in order to position the head. In the servo signal 110, a sector number 117 indicating the sector position and a burst signal 112 for measuring a position error signal are recorded.

The read head 101 reads the sector number 117 in the servo signal 110, thereby acquiring the current position of the read head. While reading the sector number 117, the read head is moved to a track (to be hereafter referred to as “a target track”) 108 containing a sector (to be hereafter referred to as “a target sector”) 107 in which information to be read is recorded. The read/write IC 106 detects an error between the sector number 117 that is read during the movement of the head and the target sector 107, and then determines the amount of movement based on the error information. An electric current commensurate with the amount of movement is supplied to the VCM 104 in order to move the read head 101 along the radius of the disc.

The read head 101 that has been moved to the vicinity of the target track 108 reads the burst signal 112 and detects a position error. Normally, the burst signal 112 is made up of four burst signals, namely a first burst to a fourth burst. In order to obtain a predetermined ratio among the signal amplitudes of the first burst 113, second burst 114, third burst 115 and fourth burst 116 that have been read, the read/write IC sends position control information 118 to the VCM to thereby move the position of the read head 101 finely until the head is positioned at the target track 108. When reading a data signal 111, the read head is moved to a read head position determined by the servo signal 110. In other words, the data signal 111 is not used for the positioning or position control of the read head.

A technique for positioning the read head during the reading of the data signal is disclosed in JP Patent Publication (Kokai) Nos. 2002-216443 A. In this technique, the read head is periodically vibrated in the radial direction during the reading of the data signal, such that the maximum value of the amplitude of a data readout signal or a signal similar to that is located at the center of the vibration of the read head at all times, thus controlling the position of the read head.

[Patent Document 1] JP Patent Publication (Kokai) No. 2002-216443 A

### SUMMARY OF THE INVENTION

In the majority of the conventional hard disc drives, the positioning of the read head is carried out only by utilizing the servo signal portion, which is recorded for the positioning purpose, so that it has been impossible to correct the positioning of the read head by utilizing the data signal portion. While in JP Patent Publication (Kokai) No. 2002-216443 the positioning control is performed by utilizing the data signal portion, the constant and periodic vibration of the read head causes fluctuations in the readout signal amplitude, resulting in a deterioration in S/N or erroneous detection of the head position. Further, in this technique, current must be constantly supplied to the VCM in order to vibrate the read head constantly and periodically. This creates a problem in systems that are operated on a limited power, such as a small-sized hard disc drive mounted on notebook computers that are powered by batteries, the problem being an increase in power consumption and a decrease in battery life.

In order to achieve higher recording densities, the head positioning accuracy must be increased. In the prior art, the positioning accuracy is ensured by increasing the number of positioning servo signals that are recorded, which poses a problem in increasing the data signal recording density.

In the above-described apparatuses, in case the head produces a position error during the reading of information, the readout signal is adversely affected, which would not be correctible if signal deterioration for other causes is added, resulting in a retry. If the head position error during playback is large enough, the readout signal cannot be detected and a number of retries are carried out. Further, if the write head position fluctuates during the recording of data, the track shape of the data that is recorded would be different from the shape of the track formed with reference to the servo signal on the recording medium. As a result, the readout signal would be attenuated and would be impossible to read because the read head attempts to read the signal on the track that is formed with reference to the servo signal.

The problem of the head position error is particularly pronounced in the case of the chip-on-suspension (COS) systems, in which a signal processing circuit is mounted on a suspension that supports a read/write head in order to reduce the propagation path loss between the read/write head and the signal processing circuit. In the COS systems, the signal processing circuit generates heat due to the current that flows therein, resulting in a local thermal expansion at a portion of the suspension. This causes the suspension to be deformed, thereby shifting the head from a target track position. This problem arises both when reading and writing, leading to two problems, one the deformation of the recording track and the other the position error during playback.

It is therefore an object of the invention to provide a head position error correction method whereby a position error of the read head as described above can be corrected at the data signal portion.

It is another object of the invention to provide a positioning method whereby the delay in information read time due to retries or a format loss due to an increase in the servo signal portion can be prevented by carrying out a position correction at the data signal portion.

It is yet another object of the invention to provide a positioning method whereby deterioration in the readout signal in case the recorded track shape is slightly deformed during the recording of data can be prevented.

The aforementioned objects are achieved by the invention whereby the amplitude of a readout signal obtained from a data portion is monitored and, if the amplitude of the readout signal decreases, the head is moved in such a way that the readout signal amplitude increases. When reading a data signal, a threshold is set with reference to the amplitude value of the frequency of the signal read. An intersymbol interference is caused by signals recorded temporally before and after information to be read and, as a result, the amplitude of the readout signal decreases as the recording density increases. This makes it necessary to set an amplitude threshold corresponding to the recording frequency. In the event that the amplitude of the readout signal drops below the threshold that has been set with reference to the frequency as mentioned above, the position of the read head is compulsorily shifted. This shifting of the read head is carried out until the amplitude of the signal reaches back to or exceeds the threshold. In the hard disc drives of the perpendicular recording type, in particular, the readout signal of an isolated wave becomes rectangular, and the interval of current reversal of the readout signal well corresponds with the recording frequency. As a result, the frequency component can be easily detected, which makes it possible to detect the amplitude value easily.

The invention provides a method for reproducing information recorded on a track by causing a read head to follow the track, comprising:

comparing the amplitude of a readout signal read by said read head with a preset threshold;

shifting the position of said read head in a first direction along the width of the track when the amplitude of said readout signal has dropped below said threshold;

detecting a change in the amplitude of said readout signal that is caused by said shifting; and

maintaining said shifting in said first direction if said change is in a direction in which the amplitude of the readout signal increases, or shifting said read head in a second direction that is opposite said first direction if said change is in a direction in which the amplitude of the readout signal decreases.

The invention further provides an information reproducing apparatus comprising:

an information recording medium including tracks in which information is recorded;

a drive unit for driving said information recording medium;

a read head;

a head drive unit for positioning said read head with respect to said tracks;

an amplitude detection unit for detecting the amplitude of a readout signal read by said read head; and

a head position correction unit for outputting a head position correcting signal to said head drive unit if the amplitude detected by said amplitude detection unit drops below a preset threshold, in order to shift said read head in a first direction by a minute amount, wherein:

said head position correction unit is adapted to output a head position correcting signal to said head drive unit if the amplitude detected by said amplitude detection unit decreases after said head position correcting signal has been outputted, in order to shift said read head in a second direction that is opposite said first direction by a minute amount.

In accordance with the invention, the position error of the read head is detected and corrected during the reading of data, so that the deterioration of readout signal can be reduced. Further, the read head can be positioned at the center of a track with reference to the shape of the tracks in which a signal is recorded during the recording of data, the shape of the tracks being different from the physical track shape that is formed concentrically with reference to the rotation center of the recording medium. As a result, reduction in the performance of the apparatus due to an increasing number of retries caused by the position error or the read head can be prevented. Further, the positioning accuracy of the head can be ensured without increasing the number of servo signal portions, so that reductions in format efficiency can be prevented.

### BRIEF DESCRIPTION OF THE DRAWINGS

FIG. 1 shows a method of correcting the head position during data signal reproduction according to the invention.

FIG. 2 is a diagram of a conventional hard disc drive.

FIG. 3 shows the arrangement of signals in a track.

FIG. 4 shows a specific example of an information reproducing apparatus according to the invention.

FIG. 5 shows the relationship between recording frequency and readout output.

FIG. 6 shows the placement of a signal processing circuit in a conventional hard disc drive.

FIG. 7 shows the placement of a signal processing circuit in a hard disc drive utilizing the COS scheme.

FIG. 8 is a drawing for the explanation of a head position correcting method for the hard disc drive utilizing the COS scheme.

FIG. 9 shows an example an information reproducing apparatus in which different types of encoding are carried out between adjacent tracks.

FIG. 10 shows the frequency characteristics in the case where different types of encoding are carried out between adjacent tracks.

### DESCRIPTION OF THE PREFERRED EMBODIMENTS

Embodiments of the information reproducing apparatus according to the invention will be described, where the invention is adapted for hard disc drives.

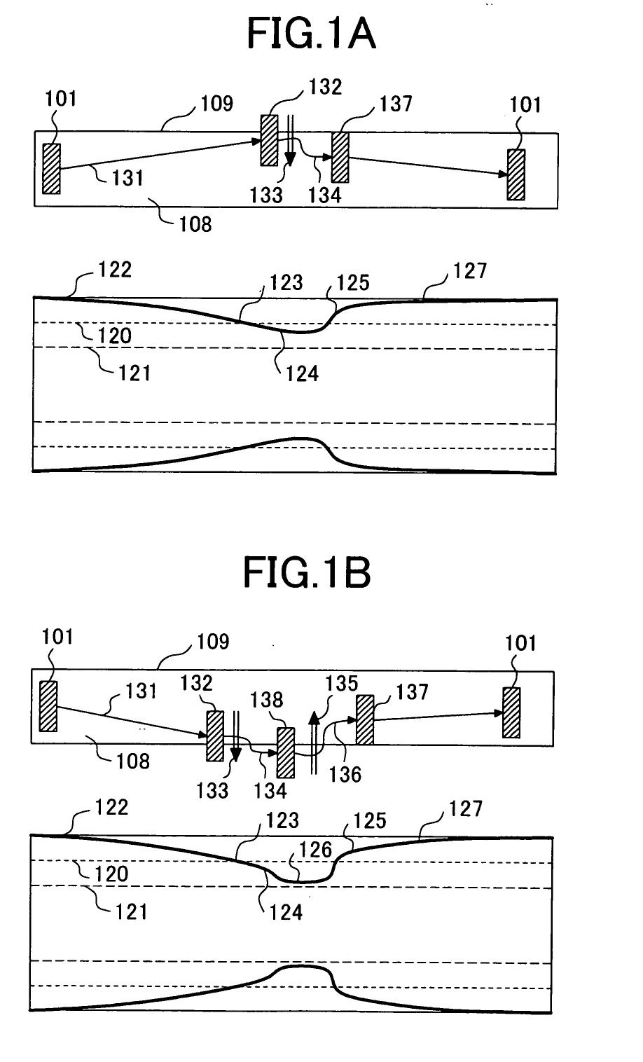

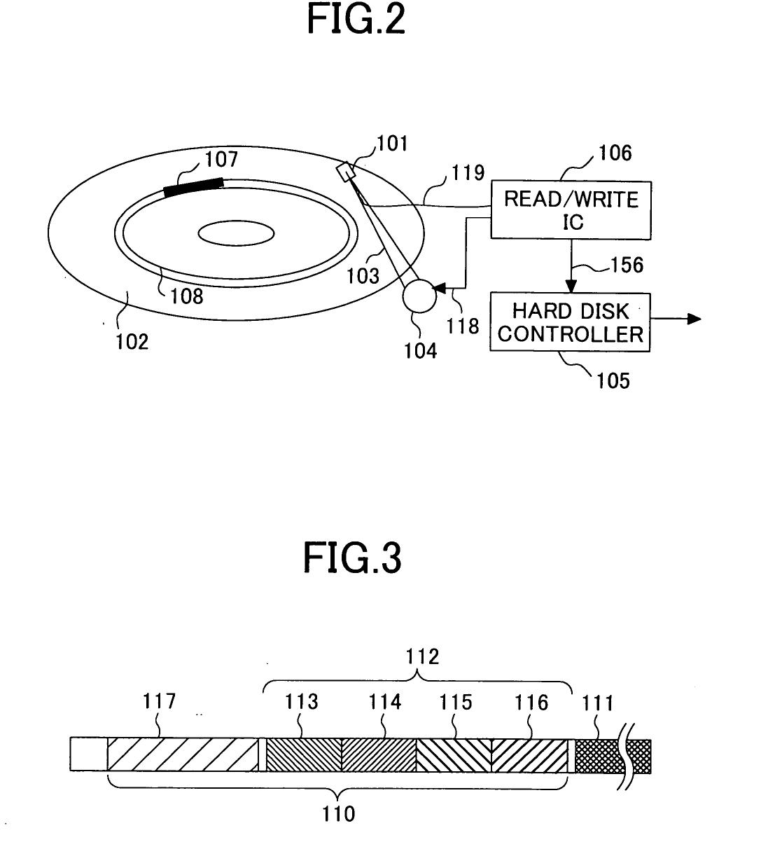

FIG. 1 shows a head position correcting method according to the invention, where a data signal is being read. In FIGS. 1(a) and 1(b), the positional relationship between a track and the read head is shown at the top, while an envelope of a corresponding readout signal is shown at the bottom. The horizontal axis indicates time, indicating the position of the read head over the track as it changes with time, and how the envelope of the readout signal changes accordingly. In the hard disc drives, a sensitive magneto-resistive effect element is used in the read head.

In the envelope 122 of the readout signal, two threshold values are set. A first threshold 120 is set to be a value 123 of the envelope of the readout signal when the read head 101 is located at an edge 109 of a track 108. The first threshold 120 does not have to be the envelope when the read head 101 is located at the edge of the track 108 strictly, as long as the conditions to be described later are met. The second threshold 121 is set to be the value of the envelope when an error begins to develop in the readout signal as the position error of the read head with respect to the track center increases.

Now referring to FIG. 1(a), an example of a procedure for correcting the position of the read head will be described. This example involves the case where the initial direction of movement of the read head was correct.

The read head 101 is positioned at the target track 108 on a recording medium 102. This positioning is carried out based on servo information 119 obtained by reading a servo signal 110. The read head 101 positioned at the target track 108 using the servo signal 110 then reads a data signal 111. If the read head 101 is not flying in parallel with the track 108 (131), the read head 101 begins to cross over an edge 109 of the track 108 after a certain time (132). As a result, the envelope of the readout signal drops below the first threshold 120 (124). As the drop of the envelope of the readout signal below the first threshold is detected, a first shift 133 is carried out in order to shift the read head 101 in a preset direction by a minute width. If the envelope 122 of the readout signal exceeds the first threshold 120 as a result of the first shift (125), the first shift 133 is carried out until the envelope of the readout signal reaches a maximum. It should be noted, however, that the first shift does not have to be conducted until the readout signal reaches a maximum in a strict sense. Namely, the first shift may be terminated upon the envelope of the readout signal exceeding the first threshold 120.

Referring to FIG. 1(b), another example of the procedure for correcting the position of the read head will be described. This example involves the case where the initial direction of the movement of the read head was wrong.

The read head 101 is positioned at the target track 108 on the recording medium 102 based on the servo information 119 obtained by reading the servo signal 110. If the read head 101 reading the data signal 111 is not flying in parallel with the track 108 (131), the read head 101 begins to cross over the edge 109 of the track 108 after a certain duration of time (132). As a result, the envelope of the readout signal drops below the first threshold 120 (124). Upon detection of the drop of the envelope of the readout signal below the first threshold, the first shift 133 is effected in order to shift the read head 101 in a preset direction by a minute width. If the envelope 122 of the readout signal drops as a result of this first shift (126), a second shift 135 is carried out in a direction opposite to that of the first shift 133. If the readout signal exceeds the first threshold 120 following the second shift 135 (125), the second shift 135 is terminated. The condition for terminating the second shift 135 is similar to that for the first shift 133 described with reference to FIG. 1(a), namely the second shift 135 is terminated when the envelope of the readout signal reaches a maximum, or when it exceeds the first threshold.

The first shift 133 and the second shift 135 are controlled such that the envelope 122 of the readout signal does not drop below the second threshold 121 for sure. The first threshold 120 is set such that the envelope 122 of the readout signal does not drop below the second threshold 121 in case the first shift 133 fails to correct the envelope of the readout signal.

In accordance with this head position correction method, the head position can be corrected by detecting the envelope of the readout signal even during the reading of data. Thus, the problem that data cannot be read due to a position error of the read head can be prevented. When there is no position error produced in the read head, a constant amplitude of the readout signal can be obtained as the read head is fixed over a track, so that the S/N of the readout signal can be maintained.

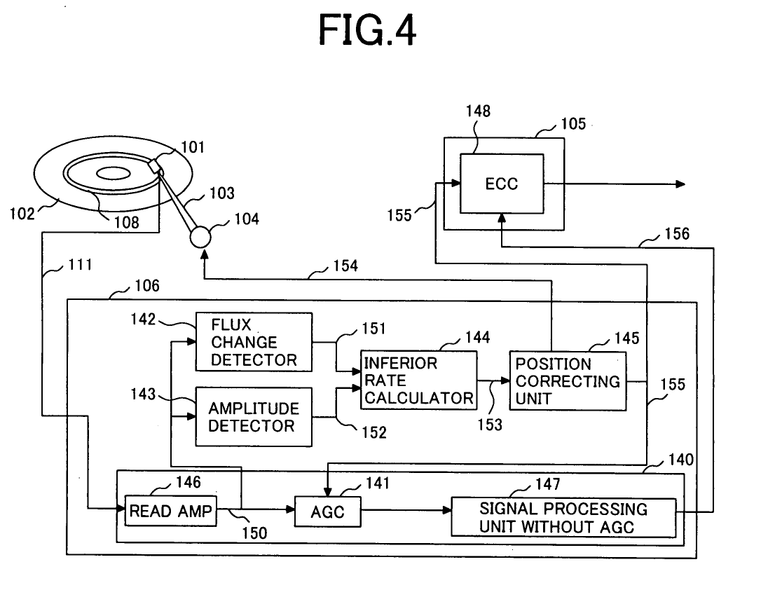

Referring now to FIG. 4, a specific example of the information reproducing apparatus of the invention will be described. Also, a method of setting a reference value of signal amplitude will be described with reference to FIG. 8, which shows the relationship between recording frequency and readout amplitude.

A read/write IC 106 comprises a conventional signal reproducing circuit 140 consisting of a reproducing amplifier 146, an AGC 141, and a signal correction circuit 147 without AGC. In addition, the read/write IC 106 comprises a flux change detection circuit 142 for detecting the current reversal interval of the readout signal, an amplitude detection circuit 143 for detecting the amplitude of the readout signal, an inferior rate generating circuit 144 for calculating the inferior rate of the readout signal amplitude, and a position correction circuit 145 for generating position correction information based on the inferior rate of the amplitude of the readout signal.

In this example, the thresholds are set with respect to the amplitude inferior rate of the readout signal. Specifically, the thresholds are each the inferior rate of the amplitude of the first and second thresholds as set in the first embodiment to the amplitude that is obtained when the read head is located at the center of a track.

The read head 101 is positioned at the target track 108 using the servo signal, and then the read head 101 starts reading the data signal 111. The data signal 111 recorded on the recording medium 102 is delivered via the read head 101 to the reproducing amplifier 146, which then outputs a readout signal 150 to the read/write IC 106. The readout signal 150 is fed to the conventional read processing circuit 140, flux change detection circuit 142, and amplitude detection circuit 143 within the read/write IC 106. The flux change detection circuit 142 detects the flux change interval from the readout signal 150, calculates an approximate frequency of the readout signal 150 based on the flux change interval, and then sends frequency information 151 to the inferior rate generating circuit 144. As the frequency information 151, a signal frequency suitable for the recording scheme is calculated based on the time interval of the flux change of the readout signal. For example, in the case of a magnetic recording apparatus in which a vertical recording scheme is adopted, the flux change interval is approximately one half of the recording frequency.

In parallel, the amplitude detection circuit 143 measures an instantaneous amplitude of the readout signal 150 from the inputted readout signal 150 to obtain amplitude information 152, which it outputs to the inferior rate generating circuit 144. The inferior rate generating circuit 144 determines a theoretical amplitude value on the basis of the frequency information 151 that would be obtained when the read head flies along the center of the track recorded at the frequency of the frequency information. The inferior rate generating circuit 144 then compares the theoretical amplitude value with the amplitude information 152 in order to obtain an amplitude inferior rate 153. The theoretical amplitude value is the signal amplitude that is obtained upon reading of a signal recorded across the recording track width at a single frequency. Thus, the signal amplitude information corresponding to the recording frequency in the case where the read head flies above the track accurately is set.

The theoretical amplitude value can be stored in the inferior rate generating circuit 144 in several ways. In a first method, a reference value (theoretical amplitude value) of the readout signal amplitude corresponding to the recording frequency is stored in a database in advance. For example, the signal amplitude is measured in the case where a signal of a single frequency is recorded and read using a read/write head mounted on an apparatus and a recording medium. The measured value is then stored in a database in the inferior rate generating circuit 144. In the vertical recoding scheme, the relationship between recording frequency and signal amplitude is roughly as shown in FIG. 8. In FIG. 8, the output amplitude is standardized by a readout waveform (to be hereafter referred to as an isolated waveform) that is obtained when a signal is recorded at a low frequency and there is no intersymbol interference. As the recording frequency varies depending on the combination of the head and the medium, the relationship shown in FIG. 8 is just an example. The measured values may have values corresponding to each frequency. Alternatively, the frequency band may be divided into regions in which the amplitude values do not vary greatly, and then a representative value set for each frequency band may be employed. The measurement values may also be calculated by utilizing output values standardized by the isolated waveform (to be hereafter referred to as “resolution”), i.e., by utilizing the isolated waveform output and the resolution. In a second method, an approximate function indicating the relationship between recording frequency and signal amplitude as shown in FIG. 8 is created and stored.

The position correction circuit 145 receives the amplitude inferior rate 153 from the inferior rate generating circuit 144 and monitors it for a certain period of time. If the amplitude inferior rate deteriorates in the certain time period and exceed a preset first threshold of the amplitude inferior rate, the position correction circuit 145 causes a VCM control current 154 to flow to the VCM 104 in order to move the read head 101, thereby shifting the read head 101 by a minute width (a first shift). Further, the position correction circuit 145 delivers read head movement information 155 to the AGC circuit 141 and the error detection circuit 148. The AGC circuit 141 and the error detection circuit 148 then correct the fluctuation of the readout signal caused by the first shift.

In response to the head movement information 155, the AGC circuit 141 corrects the signal gain such that the fluctuation of the output signal by the first shift can be reduced. As a result of this correction of the signal gain by the AGC circuit 141, noise components in the readout signal are also amplified. Thus, the error detection circuit 148 corrects the detection method by reducing the reliability of the portion of readout data 156 where the noise component has been amplified, such that the fluctuation of the readout output due to the shift or the influence of the increase in noise can be eliminated. These corrections of the fluctuation of the readout signal do not necessarily have to be performed by both the AGC circuit 141 and the error detection circuit 148, i.e., they may be performed only by the latter. Alternatively, depending on the modulation method, the corrections may be performed at the stage of the signal processing unit without AGC 147.

The reading operation is continued during the first shift of the read head 101, and the flux change information 151 and amplitude information 152 are created by the same procedure, and the amplitude inferior rate 153 is calculated. The position correction circuit 145 terminates the supply of the VCM control current 154 to the VCM 104 upon the return of the amplitude inferior rate 153 within the first threshold. If the amplitude inferior rate 153 increases as a result, the polarity of the VCM control current 154 is reversed, and a shift (a second shift) is carried out in the opposite direction by a minute width.

In accordance with the present embodiment, the position error can be corrected even when the read head has been displaced from the track center during the reading of data.

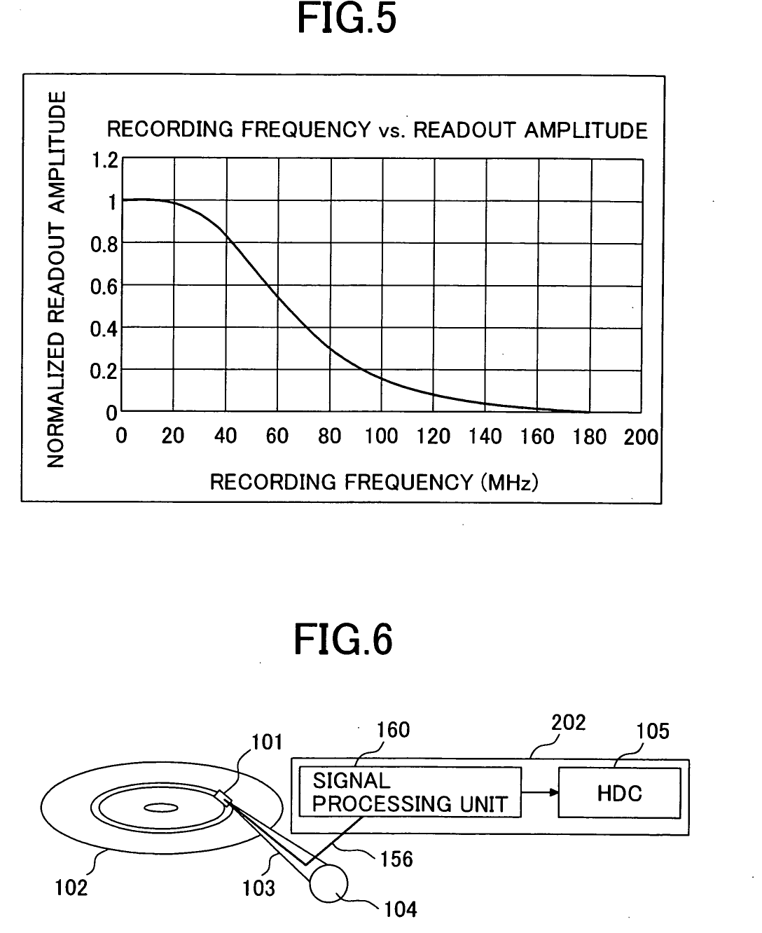

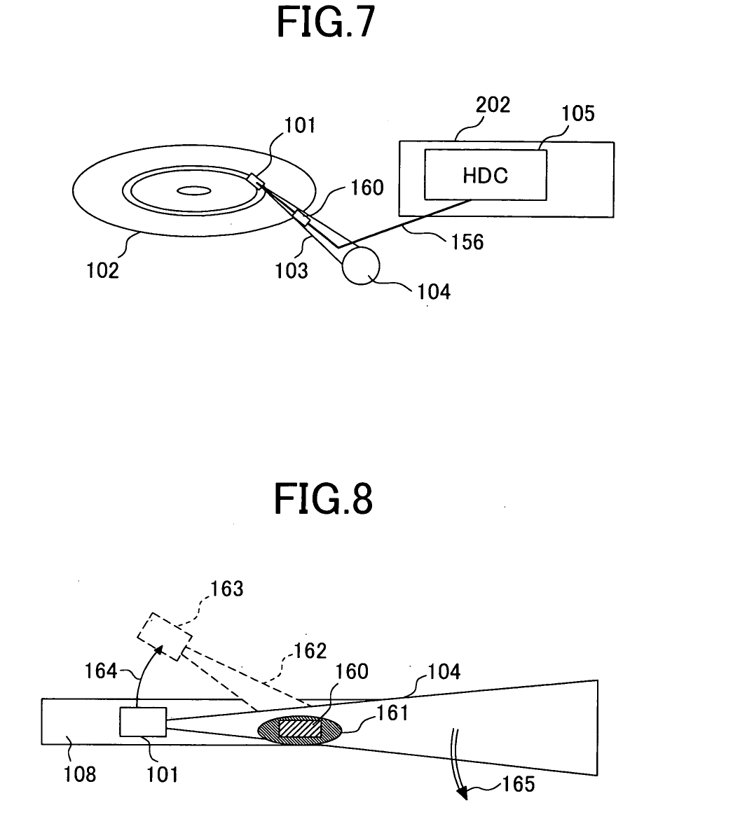

Hereafter, an example of a hard disc drive of the COS type will be described. In the conventional hard disc drive, a signal processing circuit 160 is not mounted on a suspension 103 but it is disposed on a circuit substrate 202 on which a HDC 105, for example, is mounted, as shown in FIG. 6. In contrast, in the hard disc drive of the COS type, the signal processing circuit 160 is mounted on the suspension 103, as shown in FIG. 7.

FIG. 8 illustrates a head position correction method for the hard disc drive of the COS type. In the information reproducing apparatus of the COS type, as the signal processing circuit 160 is mounted on the suspension 103, a part 161 of the suspension is deformed by heat expansion (162) caused by the heat produced by the signal processing circuit 160, resulting in a position error of the read head 101 (163). The position 161 of thermal expansion of the suspension is dependent on the location where the signal processing circuit 160 is installed. Thus, as the signal processing circuit is positioned at a fixed location, the direction of deformation of the suspension is constant. Accordingly, a direction of position error 164 due to thermal expansion is fixed. In this case, therefore, the direction of the first shift should be a direction 165 for canceling the position error due to thermal expansion. If the direction of the position error due to thermal expansion is determined and the amount of the position error is very large, the mechanism for the second shift may be omitted.

In accordance with the above-described embodiment, the position error caused by the heat produced in the signal processing circuit can be corrected even in apparatuses of the COS type.

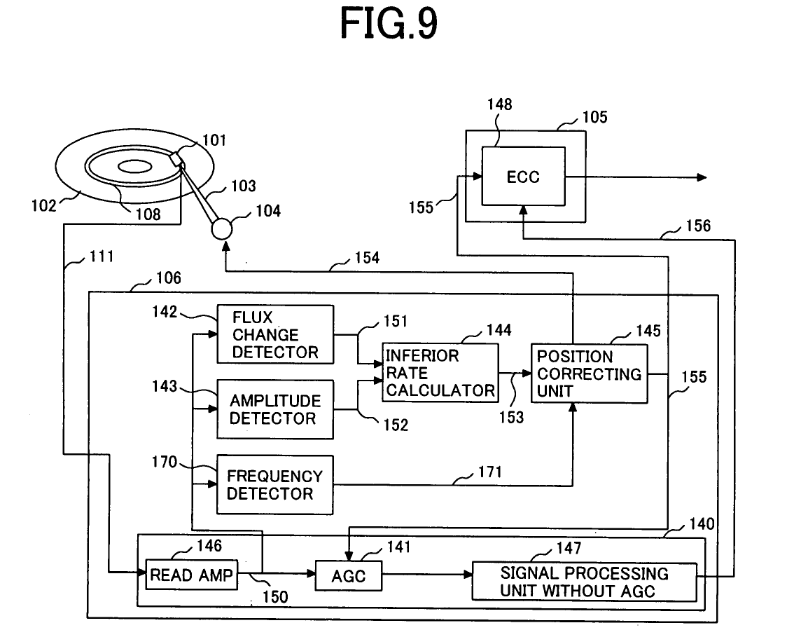

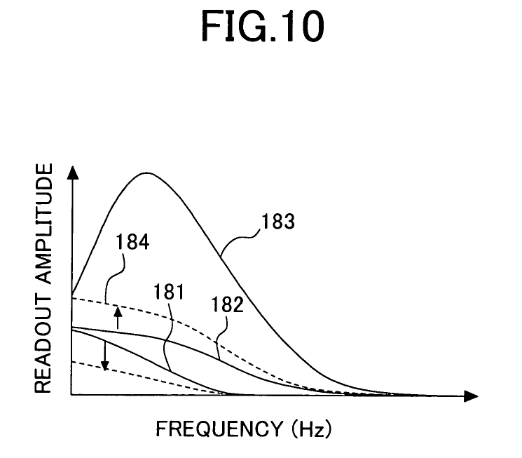

Hereafter, an example will be described where the present invention is adapted for an information reproducing apparatus in which different types of encoding or signal processing have been conducted between adjacent tracks. FIG. 9 shows an example of the information reproducing apparatus in which different types of encoding or signal processing have been conducted between adjacent tracks. FIG. 10 shows the frequency components of a target track and an adjacent track.

When recording information, encoding or signal processing with different characteristics is carried out in tracks adjacent to each other on the left and right with respect to a certain track. For example, the frequency characteristics are varied between the left and right adjacent tracks. In the following, an example of an apparatus in which a signal processing with different frequency distributions is performed on the left and right adjacent tracks will be described.

A read/write IC 106 comprises a conventional signal reproducing circuit 140 consisting of a reproducing amplifier 146, AGC 141, and a signal correcting circuit 147 without AGC. It also comprises a flux change detection circuit 142, an amplitude detection circuit 143, an inferior rate generating circuit 144, a position correction circuit 145, and a frequency component detection circuit 170 for detecting the frequency components contained in the readout signal. A read head 101 is positioned at a target track 108 using a servo signal 110 and it then starts reading a data signal 111. The data signal 111 recorded on a recording medium 102 is delivered via the read head 101 to a reproducing amplifier 146 which then outputs a readout signal 150 to the read/write IC 106. The readout signal 150 is fed to the conventional read processing circuit 140, the flux change detection circuit 142, the amplitude detection circuit 143, and the frequency component detection circuit 170 within the read/write IC 106. The flux change detection circuit 142 generates frequency information 151, while the amplitude detection circuit 143 generates amplitude information 152, and these information are delivered to the inferior rate generating circuit 144. The inferior rate generating circuit 144 generates an amplitude inferior rate 153 and delivers it to the position correction circuit 145.

In parallel, the frequency component detection circuit 170 detects frequency components 181 and 182 of the adjacent tracks from the readout signal, monitors the power ratio of the frequency components 181 and 182, and then generates ratio information 171 indicating the power ratio. In FIG. 10, the numeral 181 designates the frequency component of the left adjacent track, the numeral 182 designates the frequency component of the right adjacent track, and the numeral 183 designates the frequency component increased by the position error in a frequency component 184 of a central track.

The position correction circuit 145 monitors the amplitude inferior rate 153 and, if the inferior rate exceeds a first threshold of the preset amplitude inferior rate, receives the ratio information 171 from the frequency component detection circuit 170. Based on the ratio information 171, the position correction circuit 145 delivers a VCM control current 154 to the VCM, in order to move the read head 101 in a direction (left) different from the track 184 in which the signal component increased (in the case of FIG. 10, the frequency component 182 of the right track has increased to the frequency component 184 due to position error), thereby shifting the read head by a minute width (first shift). The position correction circuit 145 further delivers read head movement information 155 to the AGC circuit 141 and error detection circuit 148. The AGC circuit 141 and error detection circuit 148 then correct the fluctuation of the readout signal caused by the first shift. In accordance with the present embodiment, the direction of position error during playback can be determined and the position correction can be performed only by the first shift.

While the preferred embodiments of the invention have been described, it is to be understood that modifications will be apparent to those skilled in the art within the scope of the invention. For example, while the circuit for position correction is installed within the read/write IC in the above description, it may be disposed outside the read/write IC. Or the current for the fine movement of the read head, which has been described to be supplied directly to the VCM, may be fed to a VCM control unit for the same operation. Further, while the invention has been described with reference to hard disc drives, it is possible to adapt the invention for other devices, such as a signal control circuit for position control, integrated circuits, magnetooptical disc devices, optical disc devices, and floppy disc devices, for example.

Thus, in accordance with the invention, the position of the head can be corrected even during the reading of a data signal.

What is claimed is:

1. A method for reproducing information recorded on a track by causing a read head to follow the track, comprising:
comparing the amplitude of a readout signal read by said read head with a preset threshold;
shifting the position of said read head in a first direction along the width of the track when the amplitude of said readout signal has dropped below said threshold;
detecting a change in the amplitude of said readout signal that is caused by said shifting; and
maintaining said shifting in said first direction if said change is in a direction in which the amplitude of the readout signal increases, or shifting said read head in a second direction that is opposite said first direction if said change is in a direction in which the amplitude of the readout signal decreases.

2. The method for reproducing information according to claim 1, wherein said threshold is set in accordance with the frequency of the readout signal.

3. The method of reproducing information according to claim 1, wherein different types of encoding are performed in a target track which the read head should follow, and in adjacent tracks to the left and right of said target track, and wherein said first direction is determined on the basis of the ratio of signal components contained in the readout signal, namely a signal component derived from the track adjacent to the right of said target track, to a signal component derived from the track adjacent to the left of said target track.

4. An information reproducing apparatus comprising:
an information recording medium including tracks in which information is recorded;
a drive unit for driving said information recording medium;
a read head;
a head drive unit for positioning said read head with respect to said tracks;
an amplitude detection unit for detecting the amplitude of a readout signal read by said read head; and
a head position correction unit for outputting a head position correcting signal to said head drive unit if the amplitude detected by said amplitude detection unit drops below a preset threshold, in order to shift said read head in a first direction by a minute amount, wherein:
said head position correction unit is adapted to output a head position correcting signal to said head drive unit if the amplitude detected by said amplitude detection unit decreases after said head position correcting signal has been outputted, in order to shift said read head in a second direction that is opposite said first direction by a minute amount.

5. The information reproducing apparatus according to claim 4, wherein said head position correction unit is adapted to determine if the detected amplitude is greater or smaller than a preset threshold based on an inferior rate calculated by comparing the detected amplitude with a theoretical amplitude that is obtained when said read head is positioned at the track center.

6. The information reproducing apparatus according to claim 5, further comprising a frequency information calculating unit for calculating the approximate frequency of the readout signal, wherein said head position correction unit retains a theoretical value of each frequency and is adapted to calculate said inferior rate based on amplitude information obtained by said amplitude detection unit and frequency information obtained by said frequency information calculating unit.

7. The information reproducing apparatus according to claim 4, wherein said information recording medium is a magnetic recording medium, and said read head comprises a magnetoresistive effect element.

8. The information reproducing apparatus according to claim 7, further comprising:
a suspension for supporting said read head; and
a signal processing circuit disposed on said suspension.

9. The information reproducing apparatus according to claim 4, wherein encoding of different types is performed on at least three adjacent tracks, said apparatus comprising a ratio detecting unit for detecting the ratio of signal components of said three adjacent tracks which are contained in the readout signal read by said read head, wherein said head position correction unit is adapted to determine said first direction based on an output from said ratio detecting unit.

10. The information reproducing apparatus according to claim 4, further comprising an AGC circuit and an error detection circuit as circuits for processing the readout signal from said read head, wherein said AGC circuit and/or said error detection circuit are adapted to compensate for an amplitude change in the readout signal caused by a shift in the position of said read head, in response to said head position correction signal from said head position correction unit.
